(19) United States
(12) Patent Application Publication
(10) Pub. No.: US 2012/0241190 A1
(43) Pub. Date: Sep. 27, 2012

(54) COMPOSITION FOR WIRE COATING MATERIAL, INSULATED WIRE, AND WIRING HARNESS

(75) Inventors: Tatsuya Shimada, Yokkaichi-shi (JP); Masashi Kimura, Yokkaichi-shi (JP); Kousuke Shiraki, Yokkaichi-shi (JP); Mamoru Kondou, Yokkaichi-shi (JP); Masashi Sato, Yokkaichi-shi (JP)

(73) Assignees: AUTONETWORKS TECHNOLOGIES, LTD., Yokkaichi-shi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 13/509,931

(22) PCT Filed: Nov. 19, 2010
(86) PCT No.: PCT/JP2010/070733

§ 371 Date: May 31, 2012

(30) Foreign Application Priority Data
Dec. 2, 2009 (JP) 2009-274143

(51) Int. Cl. C09D 123/26; C08K 3/22; C08K 5/378; H01B 3/44

(52) U.S. Cl. 174/110 SR; 524/504; 524/432; 524/93

(57) ABSTRACT

Provided is a composition for a wire coating material that is capable of achieving heat resistance and a mechanical property at the same time even if silane crosslinking and magnesium hydroxide that is made from a natural mineral are used in combination. The composition contains (A) silane-grafted polyolefin that defines polyolefin onto which a silane coupling agent is grafted, (B) unmodified polyolefin, (C) modified polyolefin that is modified by a functional group, (D) magnesium hydroxide that is made from a natural mineral, and (E) a cross-linking catalyst. Provided is an insulated wire including a wire coating material that contains the composition that is silane-crosslinked. Provided is a wiring harness including the insulated wire.

### TECHNICAL FIELD

The present invention relates to a composition for a wire coating material, an insulated wire, and a wiring harness, and more specifically relates to a composition for a wire coating material that is favorably used as a coating material for an insulated wire used at a location where high heat resistance is required of the insulated wire, an insulated wire using the same, and a wiring harness using the same.

### BACKGROUND ART

Conventionally, high heat resistance is required of an insulated wire for use in high temperature environment such as an engine room of an automobile. For this reason, as a coating material of the insulated wire for use in such a location, crosslinked polyvinyl chloride (PVC) that is electron irradiation crosslinked is used.

Because reduction of a halogen-containing material such as polyvinyl chloride has recently been called for from the view point of reducing loads on the global environment, the halogen-containing material has been replaced with a material that mainly contains polyolefin containing no halogen element. In order that the polyolefin may be provided with sufficient flame retardancy, a relatively large amount of magnesium hydroxide is often added there as a flame retardant.

In addition, because the electron irradiation crosslinking requires expensive facilities to cause an increase in production cost, a technique of silane crosslinking polyolefin, which is achieved by inexpensive facilities, has received attention in these years.

For example, PTL 1 discloses a non-halogenous flame-retardant silane-crosslinked polyolefin composition that is prepared by kneading, heating and crosslinking a silane graftmer (A component) and a catalyst master batch (B component), where the silane graftmer (A component) is prepared by kneading a compound and 100 parts by mass of magnesium hydroxide, the compound being prepared by graft-polymerizing a silane coupling agent that is prepared by heat-kneading 100 parts by mass of polyolefin elastomer, 1 to 3 parts by mass of silane coupling agent and 0.025 to 0.063 parts by mass of cross-linking agent, and an polyolefin elastomer, and where the catalyst master batch (B component) is prepared by impregnating 100 parts by mass of polyolefin elastomer with 1.0 to 3.12 parts by mass of cross-linking agent and 7.14 to 31.3 parts by mass of a cross-linking catalyst.

In addition, PTL 2 discloses, as a composition for a wire coating material, a resin composition for use by mixing with silane-crosslinked polyolefin, the resin composition containing 100 parts by mass of polymer that is selected from a group consisting of a thermoplastic resin, rubber and a thermoplastic elastomer, 0.01 to 0.6 parts by mass of organic peroxide, 0.05 to 0.5 parts by mass of silanol condensation catalyst, and 100 to 300 parts by mass of magnesium hydroxide.

### CITATION LIST

### Patent Literature

PTL 1: Patent JP 2000-212291
PTL 2: Patent JP 2006-131720

### SUMMARY OF INVENTION

### Technical Problem

However, the conventional composition for the wire coating material needs to be improved in the following respects. To be specific, the conventional composition has a problem in achieving heat resistance and a mechanical property at the same time when using the silane crosslinking and magnesium hydroxide that is made from a natural mineral in combination. This is because in improving heat resistance with the use of the silane crosslinking without using the electron irradiation crosslinking, if the magnesium hydroxide that is made from a natural mineral is used as a flame retardant instead of magnesium hydroxide that is made from seawater by chemical synthesis, a mechanical property such as wear resistance and tensile elongation of the composition degrades remarkably.

The present invention is made in view of the problem described above, and an object of the present invention is to provide a composition for a wire coating material that is capable of achieving heat resistance and a mechanical property at the same time even if silane crosslinking and magnesium hydroxide that is made from a natural mineral are used in combination. In addition, other objects of the present invention are to provide an insulated wire and a wiring harness that are excellent in heat resistance and a mechanical property.

### Solution to Problem

To achieve the objects and in accordance with the purpose of the present invention, a composition for a wire coating material of a preferred embodiment of the present invention contains (A) silane-grafted polyolefin that defines polyolefin onto which a silane coupling agent is grafted, (B) unmodified polyolefin, (C) modified polyolefin that is modified by a functional group, (D) magnesium hydroxide that is made from a natural mineral, and (E) a cross-linking catalyst.

It is preferable that the content of (A) the silane-grafted polyolefin is 30 to 90 parts by mass, the total content of (B) the unmodified polyolefin and (C) the modified polyolefin that is modified by the functional group is 10 to 70 parts by mass, and the content of the (D) magnesium hydroxide that is made from the natural mineral is 30 to 200 parts by mass with respect to 100 parts by mass of the total content of the (A), (B) and (C) components.

It is preferable that the functional group defines a one or a plurality of functional groups selected from the group consisting of a carboxylic acid group, an acid anhydride group, an amino group, and an epoxy group.

It is preferable that the polyolefin defines a one or a plurality of polyethylene selected from the group consisting of ultralow density polyethylene, linear low density polyethylene, and low density polyethylene.

It is preferable that the composition further contains (F) at least one of a zinc oxide, and a benzimidazole compound.

In another aspect of the present invention, an insulated wire of a preferred embodiment of the present invention includes a wire coating material that contains the composition for the wire coating material that is silane-crosslinked.

Yet, in another aspect of the present invention, a wiring harness of a preferred embodiment of the present invention includes the insulated wire.

### Advantageous Effects of Invention

Containing (A) the silane-grafted polyolefin that is the polyolefin onto which the silane coupling agent is grafted, (B) the unmodified polyolefin, (C) the modified polyolefin that is modified by the functional group, (D) the magnesium hydroxide that is made from the natural mineral, and (E) the cross-linking catalyst, the composition for the wire coating material of the present embodiment of the present invention is capable of achieving great heat resistance and an excellent mechanical property at the same time even if silane-crosslinked.

If the content of (A) the silane-grafted polyolefin is 30 to 90 parts by mass, the total content of (B) the unmodified polyolefin and (C) the modified polyolefin that is modified by the functional group is 10 to 70 parts by mass, and the content of (D) the magnesium hydroxide that is made from the natural mineral is 30 to 200 parts by mass with respect to 100 parts by mass of the total content of the (A), (B) and (C) components, a harmonious balance can be maintained between heat resistance and a mechanical property of the composition.

If the functional group defines the one or the plurality of functional groups selected from the group consisting of the carboxylic acid group, the acid anhydride group, the amino group, and the epoxy group, the composition can obtain a favorable adhesion property between (C) the modified polyolefin and (D) the magnesium hydroxide that is made from the natural mineral, which can contribute to improvement in mechanical property.

If the polyolefin defines the one or the plurality of polyethylene selected from the group consisting of the ultralow density polyethylene, the linear low density polyethylene, and the low density polyethylene, the composition can improve in elongation property, which can contribute to improvement in flexibility of a wire.

If the composition further contains (F) the at least one of the zinc oxide, and the benzimidazole compound, the contained component(s) can contribute to improvement in heat resistance.

Including the wire coating material that contains the composition for the wire coating material that is silane-crosslinked, the insulated wire of the present embodiment of the present invention is excellent in heat resistance and a mechanical property. In addition, expensive electron irradiation crosslinking or synthesized magnesium hydroxide is not used in the insulated wire, the insulated wire can contribute to cost saving.

Including the insulated wire, the wiring harness of the present embodiment of the present invention is excellent in heat resistance and a mechanical property. In addition, expensive electron irradiation crosslinking or synthesized magnesium hydroxide is not used in the wiring harness, the wiring harness can contribute to cost saving.

### DESCRIPTION OF EMBODIMENTS

A detailed description of preferred embodiments of the present invention will now be provided. A composition for a wire coating material of a preferred embodiment of the present invention contains (A) silane-grafted polyolefin, (B) unmodified polyolefin, (C) modified polyolefin that is modified by a functional group, (D) magnesium hydroxide that is made from a natural mineral, and (E) a cross-linking catalyst.

(A) Silane-Grafted Polyolefin

The silane-grafted polyolefin defines polyolefin that is prepared by grafting a silane coupling agent onto the polyolefin.

Examples of the polyolefin include a homopolymer of olefin such as ethylene and propylene, an ethylene copolymer such as an ethylene-alpha-olefin copolymer, an ethylene-vinyl acetate copolymer and an ethylene-(meth)acrylic ester copolymer, a propylene copolymer such as a propylene-alpha-olefin copolymer, a propylene-vinyl acetate copolymer and a propylene-(meth)acrylic ester copolymer, and an olefin elastomer such as an ethylene elastomer and a propylene elastomer. They may be used singly or in combination.

Among them, the polyethylene, the polypropylene, the ethylene-vinyl acetate copolymer, the ethylene-acrylic ester copolymer and the ethylene-methacrylic ester copolymer are preferably used.

Examples of the polyethylene include high density polyethylene (HDPE), middle density polyethylene (MDPE), low density polyethylene (LDPE), linear low density polyethylene (LLDPE), and ultralow density polyethylene. They may be used singly or in combination. Metallocene ultralow density polyethylene is preferably used from the viewpoint of improving a tensile elongation property.

Examples of the silane coupling agent include vinylalkoxysilane such as vinyltrimethoxysilane vinyltriethoxysilane and vinyltributoxysilane, normal hexyl trimethoxysilane, vinylacetoxysilane, gamma-methacryloxypropyltrimethoxysilane, and gamma-methacryloxypropylmethyldimethoxysilane. They may be used singly or in combination.

A graft amount of the silane coupling agent (a mass ratio of the grafted silane coupling agent to the polyolefin before silane grafting is performed) is preferably 15% by mass or less, more preferably 10% by mass or less, and yet more preferably 5% by mass or less in case an unintended object is generated due to excessive crosslinking during a wire coating step. On the other hand, the graft amount is preferably 0.1% by mass or more, more preferably 1% by mass or more, and yet more preferably 2.5% by mass or more from the viewpoint of crosslinking degree (gel fraction) of the wire coat.

The silane coupling agent is grafted onto the polyolefin in a manner such that the silane coupling agent and a free-radical generating agent are added to the polyolefin to mix them all with the use of a twin-screw extruder. In addition, the silane coupling agent may be added when grafting the silane coupling agent onto the polyolefin.

The content of the silane coupling agent is preferably in the range of 0.5 to 5 parts by mass, and more preferably in the range of 2.5 to 5 parts by mass with respect to 100 parts by mass of the polyolefin onto which the silane coupling agent is to be grafted. If the content is less than 0.5 parts by mass, the graft amount of the silane coupling agent is too small, which makes it difficult for the composition to obtain a sufficient crosslinking degree during silane crosslinking. On the other hand, if the content is more than 5 parts by mass, a crosslinking reaction proceeds excessively to generate a gel-like material. In such a case, asperities are liable to appear on a product surface, which decreases mass productivity of the products. In addition, melt viscosity of the composition becomes too high and an excessive load is applied on an extruder, which results in decreased workability.

Examples of the free-radical generating agent include an organic peroxide such as dicumyl peroxide (DCP), benzoyl peroxide, dichlorobenzoyl peroxide, di-tert-butyl peroxide, butyl peracetate, tert-butyl perbenzoate, and 2,5-dimethyl-2,5-di(tert-butyl peroxy)hexane. Among them, the dicumyl peroxide (DCP) is preferably used. For example, it is preferable that when the dicumyl peroxide (DCP) is used as the free-radical generating agent, a batch for silane-grafting is adjusted to be 200 degrees C. or more in order to graft-polymerize the silane coupling agent onto the polyolefin.

The content of the free-radical generating agent is preferably in the range of 0.01 to 0.3 parts by mass, and more preferably in the range of 0.025 to 0.1 parts by mass with respect to 100 parts by mass of the polyolefin to be silane-modified. If the content is 0.01 parts by mass or less, a grafting reaction does not proceed sufficiently, which makes it difficult for the composition to obtain a desired gel fraction. On the other hand, if the content is 0.3 parts by mass or more, crosslinking of the peroxide unintentionally proceeds. Thus, when the composition is extrusion-coated on a conductor to form a wire coating material thereon, asperities appear on a surface of the wire coating material and the wire coating material is liable to have marred surface appearance. In addition, melt viscosity of the composition becomes too high and an excessive load is applied on an extruder, which results in decreased workability.

(B) Unmodified Polyolefin

The unmodified polyolefin defines polyolefin that is not modified by a functional group. Specific examples of the polyolefin include the polyolefin of (A), which is described above, and thus a detailed description thereof is omitted.

(C) Modified Polyolefin Modified by Functional Group

Specific examples of the polyolefin from which the modified polyolefin that is modified by the functional group is made include the polyolefin of (A), which is described above, and thus a detailed description thereof is omitted.

Examples of the functional group include a carboxylic acid group, an acid anhydrous group, an amino group, an epoxy group, a silane group, and a hydroxyl group. Among them, the carboxylic acid group, the acid anhydrous group, the amino group, and the epoxy group are preferably used. This is because the composition can obtain a favorable adhesion property between (C) the modified polyolefin and (D) the magnesium hydroxide that is made from the natural mineral, which can contribute to improvement in mechanical property. The modified polyolefin may contain a one or a plurality of these functional groups. In addition, a one or a plurality of modified polyolefins may be used, which are selected from modified polyolefins of a same kind that are modified by different functional groups, modified polyolefins of different kinds that are modified by different functional groups, and modified polyolefins of different kinds that are modified by functional groups of a same kind.

The content of the functional group in the modified polyolefin that is modified by the functional group is preferably in the range of 0.01 to 20% by mass, more preferably in the range of 0.05 to 15% by mass, and yet more preferably in the range of 0.1 to 10% by mass. If the content is in these ranges, a harmonious balance can be maintained between an effect of modification by the functional group and decortication ability when used for the wire coating material.

The polyolefin is modified by the functional group in a method of graft-polymerizing a compound containing the functional group onto the polyolefin, or in a method of copolymerizing a compound containing the functional group and an olefin monomer to obtain an olefin copolymer.

Examples of the compound for introducing the carboxylic acid group and/or the acid anhydrous group that are defined as the functional group include an alpha, beta-unsaturated dicarboxylic acid such as a maleic acid, a fumaric acid, a citraconic acid and an itaconic acid, anhydrides thereof, and an unsaturated monocarboxylic acid such as an acrylic acid, a methacrylic acid, a fran acid, a crotonic acid, a vinylacetic acid and a pentane acid.

Examples of the compound for introducing the amino group that is defined as the functional group include aminoethyl(meth)acrylate, propylaminoethyl(meth)acrylate, dimethylaminoethyl(meth)acrylate, diethylaminoethyl(meth)acrylate, dibutylaminoethyl(meth)acrylate, aminopropyl(meth)acrylate, phenylaminoethyl(meth)acrylate, and cyclohexylaminoethyl(meth)acrylate.

Examples of the compound for introducing the epoxy group that is defined as the functional group include glycidyl acrylate, glycidyl methacrylate, an itaconic monoglycidyl ester, a butene tricarboxylic acid monoglycidyl ester, a butene tricarboxylic acid diglycidyl ester, a butene tricarboxylic acid triglycidyl ester, glycidyl esters such as an alpha-chloroacrylic acid, a maleic acid, a crotonic acid and a fumaric acid, glycidyl ethers such as a vinyl glycidyl ether, an allyl glycidyl ether, a glycidyl oxyethyl vinyl ether and a styrene-p-glycidyl ether, and p-glycidyl styrene.

(D) Magnesium Hydroxide Made from Natural Mineral

The magnesium hydroxide that is made from the natural mineral is used as magnesium hydroxide for the composition for the wire coating material of the present invention. The magnesium hydroxide that is made from the natural mineral is typically obtained by pulverizing a natural mineral which is mainly composed of magnesium hydroxide. For this reason, the magnesium hydroxide that is made from the natural mineral has larger surface asperities than synthesized magnesium hydroxide that is synthesized from a magnesium source contained in seawater.

The magnesium hydroxide has a particle size of preferably 20 ·m or less, more preferably 10 ·m or less, and yet more preferably 5 ·m or less from the viewpoint of obtaining excellent surface appearance when used for the wire coating material. On the other hand, the particle size is preferably 0.5 ·m or more, considering that secondary cohesion is hardly brought about and a mechanical property of the composition hardly degrades.

Because having large surface asperities as described above, the magnesium hydroxide that is made from the natural mineral basically has an unfavorable adhesion property to the polymer component. In order to obtain a favorable adhesion property to the polymer component, the magnesium hydroxide that is made from the natural mineral may be subjected to a surface treatment with the use of a surface treatment agent.

Examples of the surface treatment agent include a silane coupling agent, a titanate coupling agent, a fatty acid compound, a fatty acid salt compound, a fatty acid ester compound, and an olefin wax. They may be used singly or in combination. The surface treatment with the use of the surface treatment agent is performed preferably within the range of 0.1 to 10% by mass, and more preferably within the range of 0.5 to 5% by mass with respect to 100 parts by mass of the magnesium hydroxide made from the natural mineral. If the treatment is performed within these ranges, a harmonious balance can be maintained between an effect of improving a mechanical property of the composition when used for the wire coating material and an effect of suppressing degradation of a mechanical property of the composition when used for the wire coating material due to the surface treatment agency remaining as impurities therein.

The composition for the wire coating material of the present embodiment of the present invention contains the magnesium hydroxide that is made from the natural mineral as an essential component; however, the composition may contain also synthesized magnesium hydroxide. In such a case, the content of the synthesized magnesium hydroxide is made less than that of the magnesium hydroxide that is made from the natural mineral from the viewpoint of the purpose of the present invention and cost saving.

(E) Cross-Linking Catalyst

The cross-linking catalyst defines a silanol condensation catalyst for silane crosslinking the silane-grafted polyolefin. Examples of the cross-linking catalyst include a metal carboxylate containing a metal such as tin, zinc, iron, lead and cobalt, a titanate ester, an organic base, an inorganic acid, and an organic acid.

Specific examples of the cross-linking catalyst include dibutyltin dilaurate, dibutyltin dimalate, dibutyltin mercaptide (e.g., dibutyltin bis-octylthioglycolate, a dibutyltin beta-mercaptopropionate polymer), dibutyltin diacetate, dibutyltin dilaurate, stannous acetate, stannous caprylate, lead naphthenate, cobalt naphthenate, barium stearate, calcium stearate, tetrabutyl titanate, tetranonyl titanate, dibutylamine, hexylamine, pyridine, a sulfuric acid, a hydrochloric acid, a toluenesulfonic acid, an acetate, a stearic acid, and a maleic acid. Among them, the dibutyltin dilaurate, the dibutyltin dimalate, and the dibutyltin mercaptide are preferably used.

The composition for the wire coating material of the present embodiment of the present invention contains the components of (A) to (E) described above. It is preferable that the composition further contains (F) a zinc oxide and/or a benzimidazole compound. The contained component(s) can contribute to improvement in heat resistance.

It is possible to replace a part or the whole of the zinc oxide with a zinc sulfide. A benzimidazole compound containing sulfur is preferably used as the benzimidazole compound. Specific examples of the benzimidazole compound include 2-mercaptobenzimidazole, 2-mercaptomethylbenzimidazole, 4-mercaptomethylbenzimidazole, 5-mercaptomethylbenzimidazole, and zinc salt thereof. Among them, the 2-mercaptobenzimidazole and the zinc salt thereof are preferably used. The benzimidazole compound may have a substituent such as an alkyl group at other positions of benzimidazole skeletons.

It is preferable that the composition for the wire coating material of the present embodiment of the present invention further contains one kind or more than one kind of additive within a range of not impairing the properties of the wire. Examples of the additive include a lubricant such as a stearic acid, an antioxidant, a copper inhibitor an ultraviolet absorber, a processing aid (e.g., wax, lubricant), a flame-retardant auxiliary agent and a coloring agent.

In the composition for the wire coating material of the present embodiment of the present invention, the content of (A) the silane-grafted polyolefin is 30 to 90 parts by mass, preferably 40 to 80 parts by mass, and more preferably 50 to 70 parts by mass, the total content of (B) the unmodified polyolefin and (C) the modified polyolefin that is modified by the functional group is 10 to 70 parts by mass, preferably 20 to 60 parts by mass, and more preferably 30 to 50 parts by mass, and the content of (D) the magnesium hydroxide that is made from the natural mineral is 30 to 200 parts by mass, preferably 50 to 120 parts by mass, and more preferably 60 to 100 parts by mass with respect to 100 parts by mass of the total content of the (A), (B) and (C) components. This is because a harmonious balance can be maintained among heat resistance, a mechanical property and flame retardancy of the composition.

It is preferable that the mixing ratio between

(B) the unmodified polyolefin and (C) the modified polyolefin that is modified by the functional group: (B)/(C) is in the range of 95/5 to 50/50, and preferably in the range of 90/10 to 70/30 in mass ratio. If the mixing ratio is within these ranges, the composition contributes to cost effect, and has advantages of suppressing an excessive reaction by the functional group.

In addition, the content of (E) the cross-linking catalyst is preferably in the range of 0.3 to 10 parts by mass, and more preferably in the range of 0.5 to 5 parts by mass with respect to 100 parts by mass of (A) the silane-grafted polyolefin. The content of 0.5 parts by mass or more allows the composition to obtain an appropriate crosslinking degree and to improve in heat resistance. In addition, the content of 5 parts by mass or less allows the composition to improve surface appearance when used for the wire coating material.

In addition, the content of (F) the zinc oxide and/or the benzimidazole compound is preferably in the range of 1 to 20 parts by mass, and more preferably in the range of 3 to 10 parts by mass with respect to 100 parts by mass of the total content of the (A), (B) and (C) components. The content of 1 part by mass or more allows the composition to improve in heat resistance. In addition, the content of 20 parts by mass or less prevents particle cohesion, allows the composition to improve surface appearance when used for the wire coating material, and little exerts a harmful influence on a mechanical property such as wear resistance of the composition.

In addition, the content of the lubricant such as the stearic acid is preferably 5 parts by mass or less, and more preferably 3 parts by mass or less with respect to 100 parts by mass of the resin component except the lubricant. The lubricant has an effect of improving surface appearance of the composition when used for the wire coating material; however, excessive addition of the lubricant exerts a harmful influence on workability of a wire and workability of a wiring harness.

The composition for the wire coating material of the present embodiment of the present invention can be prepared by heat-kneading (A) the silane-grafted polyolefin, (B) the unmodified polyolefin, (C) the modified polyolefin that is modified by the functional group, (D) the magnesium hydroxide that is made from the natural mineral and (E) the cross-linking catalyst, and the additive(s) if needed, with the use of a generally used kneader such as a Banbury mixer, a pressure kneader, a kneading extruder, a twin-screw extruder and a roll, molding the heat-kneaded composition. Then, the silane-grafted polyolefin is silane-crosslinked (water-crosslinked), and the crosslinked composition is prepared. The contents of the components are adjusted preferably as appropriate within the respective ranges described above.

The composition for the wire coating material of the present embodiment of the present invention is prepared preferably through the step of heat-kneading a batch that includes the silane-grafted polyolefin, or a batch that includes materials for the silane-grafted polyolefin (i.e., the polyolefin, the silane coupling agent, and the free-radical generating agent) (hereinafter, the batch is referred to as the “silane-graft batch”), a batch that includes the polyolefin(s) (unmodified and/or modified), the magnesium hydroxide made from the natural mineral that defines the flame retardant, and the cross-linking catalyst (hereinafter, the batch is referred to as the “flame-retardant batch”). Alternatively, the composition is prepared preferably through the step of heat-kneading the silane-graft batch, the flame-retardant batch excluding the cross-linking catalyst, and a batch that includes the polyolefin(s) (unmodified and/or modified) and the cross-linking catalyst (hereinafter, the batch is referred to as the “cross-linking catalyst batch”). Alternatively, the composition is prepared preferably through the step of heat-kneading the silane-graft batch, the flame-retardant batch excluding the cross-linking catalyst, and the cross-linking catalyst. After this step, the heat-kneaded components are molded in a molding step to obtain the composition. In this case too, the silane-grafted polyolefin is silane-crosslinked (water-crosslinked) later, and the crosslinked composition is prepared.

When the kneaded components prepared through these steps are extrusion-coated on a conductor to form a wire coating material thereon, asperities hardly appear on a surface of the wire coating material, and the wire coating material easily has favorable surface appearance. In addition, the melt viscosity of the kneaded components does not become too high and an excessive load is hardly applied on an extruder, which allows the composition to improve in workability.

Next, a description of an insulated wire of the present embodiment of the present invention will be provided. The insulated wire includes a conductor that is made from copper, a copper alloy, aluminum or an aluminum copper alloy, and a wire coating material coated on the conductor, the material being prepared by silane crosslinking the composition for the wire coating material described above. The diameter, the material and other properties of the conductor are not specifically limited and may be determined depending on the intended use. In addition, the thickness of the insulated coating material is not specifically limited and may be determined considering the conductor diameter. The insulated coating material may be coated in single layer, or may be coated in multi layer.

The composition for the wire coating material after the silane crosslinking preferably has a crosslinking degree of 50% more, and more preferably 60% or more from the viewpoint of heat resistance. The crosslinking degree can be adjusted in accordance with the graft amount of the silane coupling agent of the contained silane-grafted polyolefin, the kind and amount of the cross-linking catalyst, or the conditions for silane crosslinking (water-crosslinking) (temperature and duration).

The production of the insulated wire of the present embodiment of the present invention preferably includes the steps of heat-kneading the batches as described above, extrusion-coating the conductor with the heat-kneaded components, and then silane crosslinking (water crosslinking) the coating material that is extrusion-coated.

During the production, the batches that are formed into pellets can be dry-blended with the use of a mixer or an extruder in the heat-kneading step. The conductor is extrusion-coated with the wire coating material with the use of a general extrusion molding machine in the extrusion-coating step. The wire coating material formed in the extrusion-coating step can be crosslinked by being exposed to vapor or water in the crosslinking step. These steps are preferably performed under the conditions at temperatures from an ambient temperature to 90 degrees C. for 48 hours or less, more preferably at temperatures from 60 to 80 degrees C. for 12 to 24 hours.

Next, a description of a wiring harness of the present embodiment of the present invention will be provided. The wiring harness includes the insulated wires described above. The wiring harness has a configuration such that a single wire bundle composed of the insulated wires described above only, or a mixed wire bundle composed of the insulated wires described above and other insulated wires is coated with a wiring harness protective material.

The number of the wires included in the single wire bundle or the mixed wire bundle is not limited specifically, and may be arbitrarily determined.

When using the mixed wire bundle, the structure of the other insulated wires is not limited specifically. The insulated coating material may be coated in single layer, or may be coated in multi layer. In addition, the kind of the insulated coating material is not limited specifically.

In addition, the wiring harness protective material is arranged to coat the outer surface of the wire bundle to protect the wire bundle inside. Examples of the wiring harness protective material include a wiring harness protective material having a tape-shaped base material on at least one side of which an adhesive is applied, a wiring harness protective material having a tube-shaped base material, and a wiring harness protective material having a sheet-shaped base material. The wiring harness protective material is preferably chosen depending on the intended use.

Specific examples of the base material for the wiring harness protective material include non-halogenous flame-retardant resin compositions of various types, vinyl chloride resin compositions of various types, and halogenous resin compositions of various types other than the vinyl chloride resin compositions.

### Example

A description of the present invention will now be specifically provided with reference to Examples. However, the present invention is not limited thereto.

(Material Used, Manufacturer, and Other Information)

Materials used in the Examples and Comparative Examples are provided below along with their manufacturers and trade names.
Silane-grafted PP [manuf.: MITSUBISHI CHEMICAL CORPORATION, trade name: LINKLON XPM800HM]
Silane-grafted PE (1) [manuf.: MITSUBISHI CHEMICAL CORPORATION, trade name: LINKLON XLE815N (LLDPE)]
Silane-grafted PE (2) [manuf.: MITSUBISHI CHEMICAL CORPORATION, trade name: “LINKLON XCF710N” (LDPE)]
Silane-grafted PE (3) [manuf.: MITSUBISHI CHEMICAL CORPORATION, trade name: “LINKLON QS241HZ” (HDPE)]
Silane-grafted PE (4) [manuf.: MITSUBISHI CHEMICAL CORPORATION, trade name: “LINKLON SH700N” (VLDPE)]
Silane-grafted EVA [manuf.: MITSUBISHI CHEMICAL CORPORATION, trade name: “LINKLON XVF600N”]
PP elastomer [manuf.: JAPAN POLYPROPYLENE CORPORATION, trade name: “NEWCON NAR6”]
PE (1) [manuf.: DUPONT DOW ELASTOMERS JAPAN KK, trade name: “ENGAGE 8003” (VLDPE)]
PE (2) [manuf.: NIPPON UNICAR COMPANY LIMITED, trade name: “NUC8122” (LDPE)]
PE (3) [manuf.: PRIME POLYMER CO., LTD, trade name: “ULTZEX10100W” (LLDPE)]
Maleic acid denatured PE [manuf.: NOF CORPORATION, trade name: “MODIC AP512P”]
Epoxy denatured PE [manuf.: SUMITOMO CHEMICAL CO., LTD., trade name: “BONDFAST E (E-GMA)”]
Maleic acid denatured PP [manuf.: MITSUBISHI CHEMICAL CORPORATION, trade name: “ADMER QB550”]
Magnesium hydroxide made from natural mineral [manuf.: KONOSHIMA CHEMICAL CO., LTD., trade name: “MAGSEEDS W”]
Synthesized magnesium hydroxide [manuf.: KYOWA CHEMICAL INDUSTRY CO., LTD., trade name: “KISUMA 5”]
Antioxidant (1) [Manuf.: CIBA SPECIALTY CHEMICALS INC., trade name: “IRGANOX 1010”]
Antioxidant (2) [Manuf.: CIBA SPECIALTY CHEMICALS INC., trade name: “IRGANOX 1330”]
Copper inhibitor [Manuf.: ADEKA CORPORATION, trade name: CDA-2]
Zinc oxide [Manuf.: HAKUSUITECH CO., LTD., trade name: “ZINC OXIDE JIS”]
Zinc sulfide [Manuf.: SACHTLEBEN CHEMIE GMBH, trade name: “SACHTOLITH HD-S”]
Benzimidazole compound [Manuf.: KAWAGUCHI CHEMICAL INDUSTRY CO., LTD., trade name: “ANTAGE MB”]
Lubricant (1) [Manuf.: NOF CORPORATION, trade name: “ALFLOW P10” (erucic acid amide)]
Lubricant (2) [Manuf.: NOF CORPORATION, trade name: “ALFLOW S10” (stearic acid amide)]
Crosslinking catalyst [manuf.: MITSUBISHI CHEMICAL CORPORATION, trade name: “LINKLON LZ0515H”]

(Preparation of Flame-Retardant Batch)

Flame-retardant batches were prepared as follows: materials for flame-retardant batches consistent with Examples and Comparative Examples were prepared at the ratios indicated in Tables 1 and 2, and the materials for each flame-retardant batch were put into a twin-screw kneading extruder. The materials were heat-kneaded at 200 degrees C. for 0.1 to 2 minutes, and then the kneaded component was formed into a pellet. Thus, the flame-retardant batches consistent with Examples and Comparative Examples were prepared.

(Preparation of Insulated Wire)

The flame-retardant batches, the silane-grafted polyolefins, and crosslinking catalysts consistent with Examples and Comparative Examples (no silane-grafted polyolefin was added for Comparative Example 1) were prepared at the ratios indicated in Tables 1 and 2, and were kneaded by using a hopper of an extruder at about 180 to 200 degrees C., and subjected to extrusion processing. Conductors having an external diameter of 2.4 mm were extrusion-coated with thus-prepared compositions, and insulators having a thickness of 0.7 mm were formed (i.e., the external diameter of the insulated wires after the extrusion-coating was 3.8 mm). Then, the compositions were water-crosslinked in a bath at a high humidity of 95% and at a high temperature of 60 degrees C. for 24 hours. Thus, insulated wires were prepared.

Evaluations of the obtained insulated wires were made in terms of the following properties.

(Gel Content)

Gel contents of the insulated wires were measured in accordance with the JASO-D608-92. To be specific, about 0.1 g of test samples of the insulators of the insulated wires were each weighed out and put in a test tube, to which 20 ml xylene was added, and then, the test samples were each heated in a constant temperature oil bath at 120 degrees C. for 24 hours. Then, the test samples were each taken out from the test tube to be dried in a dryer at 100 degrees C. for 6 hours. The dried test samples were each cooled to a room temperature and precisely weighed. The percentages of the masses of the test samples after the test to the masses of the test samples before the test were defined as the gel contents. The test samples having a gel content of 50% or more were regarded as good, and the test sample having a gel content of less than 50% was regarded as bad. The gel content is a generally used index of a water crosslinking state of a crosslinked wire.

(Flame Retardancy)

A flame retardancy test of the insulated wires was performed in accordance with the ISO 6722. The insulated wires that were extinguished within 70 seconds were regarded as good, and the insulated wire that was extinguished over 70 seconds was regarded as bad.

(Tensile Elongation)

The measurements of tensile elongation of the insulated wires were obtained by a tensile test in accordance with the JIS C 3005. To be specific, the insulated wires were, after the conductors were removed therefrom, each cut to a length of 100 mm, and tubular test pieces including only the insulating coating materials were obtained. Then, at a room temperature of 23±5 degrees C., both the ends of each test piece were attached to chucks of a tensile tester and were pulled at a tensile speed of 200 mm/min, and the load and elongation at the time of break of each test piece were measured. The insulated wires having a tensile elongation of 125% or more were regarded as good, the insulated wires having a tensile elongation of 300% or more were regarded as excellent, and the insulated wires having a tensile elongation less than 125% were regarded as bad.

(Wear Resistance)

A wear resistance test of the insulated wires was performed in accordance with the ISO 6722. The insulated wires that could resist blade reciprocation of 500 times or more were regarded as good, and the insulated wire that could not resist the blade reciprocation of 500 times or more was regarded as bad.

(ISO Long-Time Heating Test (Heat Resistance))

An aging test of the insulated wires was performed in accordance with the ISO 6722 at 150 degrees C. for 3000 hours or 10000 hours, and then a withstand voltage test of 1 kv× for 1 minute was performed on the insulated wires. The insulated wires that stood the withstand voltage test of 1 kv× for 1 minute after the aging test of 3000 hours were regarded as good, the insulated wires that stood the withstand voltage test of 1 kv× for 1 minute after the aging test of 10000 hours were regarded as excellent, and the insulated wire that could not stand the withstand voltage test of 1 kv× for 1 minute after the aging test of 3000 hours was regarded as bad.

(Wire Surface Roughness)

The measurements of average surface roughness (Ra) of the insulated wires were obtained with the use of a needle detector (Manuf.: MITUTOYO CORPORATION, trade name: SURFTEST SJ301). The insulated wires of which Ra was less than 1 were regarded as good, the insulated wires of which Ra was less than 0.5 were regarded as excellent. It is to be noted that the surface roughness of the insulated wires is reference data.

TABLE 1

| | Example 1 | | Example 2 | | Example 3 | | Example 4 | | Example 5 | | Example 6 | |
|---|---|---|---|---|---|---|---|---|---|---|---|---|
| | Flame- | | Flame- | | Flame- | | Flame- | | Flame- | | Flame- | |
| Components | retardant | | retardant | | retardant | | retardant | | retardant | | retardant | |
| (parts by mass) | batch | — | batch | — | batch | — | batch | — | batch | — | batch | — |
| Silane-grafted PP | — | 30 | — | — | — | — | — | — | — | — | — | — |
| Silane-grafted PE (1) | — | — | — | 60 | — | — | — | — | — | — | — | — |
| Silane-grafted PE (2) | — | — | — | — | — | 90 | — | — | — | — | — | — |
| Silane-grafted PE (3) | — | — | — | — | — | — | — | 60 | — | — | — | — |
| Silane-grafted PE (4) | — | — | — | — | — | — | — | — | — | 60 | — | — |
| Silane-grafted EVA | — | — | — | — | — | — | — | — | — | — | — | 60 |
| PP elastomer | 10 | — | — | — | — | — | 5 | — | — | — | — | — |
| PE(1) | 50 | — | — | — | — | — | 30 | — | 10 | — | — | — |
| PE(2) | — | — | 30 | — | — | — | — | — | 20 | — | — | — |
| PE(3) | — | — | — | — | 5 | — | — | — | — | — | 35 | — |
| Maleic acid denatured PE | — | — | 10 | — | — | — | 5 | — | 10 | — | — | — |
| Epoxy denatured PE | 10 | — | — | — | — | — | — | — | — | — | — | — |
| Maleic acid denatured PP | — | — | — | — | 5 | — | — | — | — | — | 5 | — |
| Magnesium hydroxide made | 120 | — | 70 | — | 200 | — | 70 | — | 30 | — | 80 | — |
| from natural mineral | | | | | | | | | | | | |
| Synthesized magnesium | — | — | — | — | — | — | — | — | 30 | — | — | — |
| hydroxide | | | | | | | | | | | | |
| Crosslinking catalyst | — | 5 | — | 5 | | 5 | — | 5 | — | 5 | — | 5 |
| Zinc oxide | — | — | — | — | 5 | — | — | — | — | — | — | — |
| Zinc sulfide | — | — | — | — | — | — | 5 | — | — | — | — | — |
| Benzimidazole compound | — | — | — | — | 5 | — | — | — | — | — | — | — |
| Antioxidant (1) | 1.5 | — | 1.5 | — | 1.5 | — | 1.5 | — | 1.5 | — | 1.5 | — |
| Antioxidant (2) | 1.5 | — | 1.5 | — | 1.5 | — | 1.5 | — | 1.5 | — | 1.5 | — |
| Copper inhibitor | 1 | — | 1 | — | 1 | — | 1 | — | 1 | — | 1 | — |
| Lubricant (1) | — | — | — | — | — | — | 1 | — | — | — | 1 | — |
| Lubricant (2) | — | — | — | — | — | — | — | — | 1 | — | — | — |

| | | | | | | |
|---|---|---|---|---|---|---|
| Gel content | Good | Good | Good | Good | Good | Good |
| Flame retardancy | Good | Good | Good | Good | Good | Good |
| Tensile elongation | Good | Excellent | Excellent | Good | Excellent | Good |
| Wear resistance | Good | Good | Good | Good | Good | Good |
| ISO long-time heating test | Good | Good | Excellent | Excellent | Good | Good |
| (heat resistance) | | | | | | |
| Wire surface roughness | Good | Good | Excellent | Excellent | Excellent | Excellent |

TABLE 2

| | Comparative | | Comparative | | Comparative | |
|---|---|---|---|---|---|---|
| | Example 1 | | Example 2 | | Example 3 | |
| | Flame- | | Flame- | | Flame- | |
| Components | retardant | | retardant | | retardant | |
| (parts by mass) | batch | — | batch | — | batch | — |
| Silane-grafted PP | — | — | — | — | — | — |
| Silane-grafted PE (1) | — | — | — | 60 | — | — |
| Silane-grafted PE (2) | — | — | — | — | — | 60 |
| Silane-grafted PE (3) | — | — | — | — | — | — |
| Silane-grafted PE (4) | — | — | — | — | — | — |
| Silane-grafted EVA | — | — | — | — | — | — |
| PP elastomer | 50 | — | — | — | — | — |
| PE(1) | 50 | — | 40 | — | — | — |
| PE(2) | — | — | — | — | 20 | — |
| PE(3) | — | — | — | — | — | — |
| Maleic acid denatured | — | — | — | — | 20 | — |
| PE | | | | | | |
| Epoxy denatured PE | — | — | — | — | — | — |
| Maleic acid denatured | — | — | — | — | — | — |
| PP | | | | | | |
| Magnesium hydroxide | 70 | — | 70 | — | — | — |
| made from natural | | | | | | |
| mineral | | | | | | |
| Synthesized | — | — | — | — | — | — |
| magnesium hydroxide | | | | | | |
| Crosslinking catalyst | — | 5 | — | 5 | — | 5 |
| Zinc oxide | — | — | — | — | — | — |
| Zinc sulfide | — | — | — | — | 3 | — |
| Benzimidazole | — | — | — | — | — | — |
| compound | | | | | | |
| Antioxidant (1) | 1.5 | — | 1.5 | — | 1.5 | — |
| Antioxidant (2) | 1.5 | — | 1.5 | — | 1.5 | — |
| Copper inhibitor | 1 | — | 1 | — | 1 | — |
| Lubricant (1) | — | — | — | — | 1 | — |
| Lubricant (2) | — | — | — | — | — | — |

| | | | |
|---|---|---|---|
| Gel content | Bad | Good | Good |
| Flame retardancy | Good | Good | Bad |
| Tensile elongation | Bad | Bad | Good |
| Wear resistance | Good | Bad | Good |
| ISO long-time heating | Bad | Good | Good |
| test (heat | | | |
| resistance) | | | |
| Wire surface | Bad | Bad | Good |
| roughness | | | |

As is evident from Tables 1 and 2, the composition of Comparative Example 1 does not contain (A) the silane-grafted polyolefin, nor (C) the modified polyolefin that is modified by the functional group. For this reason, the composition of Comparative Example 1 is not silane-crosslinked, and is accordingly inferior in heat resistance. In addition, the composition of Comparative Example 1 is inferior in tensile performance.

The composition of Comparative Example 2 does not contain (C) the modified polyolefin that is modified by the functional group. For this reason, the resin component has an unfavorable adhesion property to (D) the magnesium hydroxide made from the natural mineral, and is accordingly inferior in wear resistance and tensile performance. In addition, the unfavorable adhesion property results in greatly rough wire surface and inferior surface appearance.

The composition of Comparative Example 3 does not contain (D) the magnesium hydroxide made from the natural mineral. For this reason, while being favorable in heat resistance, wear resistance and tensile performance, the composition of Comparative Example 3 does not have flame retardancy required of an insulated wire.

Meanwhile, each composition of present Examples contains (A) the silane-grafted polyolefin, (13) the unmodified polyolefin, (C) the modified polyolefin that is modified by the functional group, (D) the magnesium hydroxide that is made from the natural mineral, and (E) the cross-linking catalyst. Thus, even if containing the magnesium hydroxide that is made from the natural mineral, the compositions of present Examples are capable of achieving great heat resistance and an excellent mechanical property at the same time when silane-crosslinked.

In addition, as is evident, when the components of the compositions are within the respectively specified ranges, a harmonious balance can be maintained between heat resistance and a mechanical property of each composition. In addition, it is shown that the compositions of Examples 3 and 4 containing (F) the zinc oxide and/or the benzimidazole compound are superior in heat resistance than the compositions of the other Examples.

The foregoing description of the preferred embodiments of the present invention has been presented for purposes of illustration and description; however, it is not intended to be exhaustive or to limit the present invention to the precise form disclosed, and modifications and variations are possible as long as they do not deviate from the principles of the present invention.

1-7. (canceled)

8. A composition for a wire coating material, the composition containing:
(A) silane-grafted polyolefin that comprises polyolefin onto which a silane coupling agent is grafted;
(B) unmodified polyolefin;
(C) modified polyolefin that is modified by a functional group;
(D) magnesium hydroxide that is made from a natural mineral; and
(E) a cross-linking catalyst.

9. The composition according to claim 8,
wherein
the content of (A) the silane-grafted polyolefin is 30 to 90 parts by mass,
the total content of (B) the unmodified polyolefin and (C) the modified polyolefin that is modified by the functional group is 10 to 70 parts by mass, and
the content of the (D) magnesium hydroxide that is made from the natural mineral is 30 to 200 parts by mass with respect to 100 parts by mass of the total content of the (A), (B) and (C) components.

10. The composition according to claim 9, wherein the functional group comprises a one or a plurality of functional groups selected from the group consisting of a carboxylic acid group, an acid anhydride group, an amino group, and an epoxy group.

11. The composition according to claim 10, wherein the polyolefin comprises a one or a plurality of polyethylene selected from the group consisting of ultralow density polyethylene, linear low density polyethylene, and low density polyethylene.

12. The composition according to claim 11, further containing (F) at least one of a zinc oxide, and a benzimidazole compound.

13. The composition according to claim 10, further containing (F) at least one of a zinc oxide, and a benzimidazole compound.

14. The composition according to claim 9, wherein the polyolefin comprises a one or a plurality of polyethylene selected from the group consisting of ultralow density polyethylene, linear low density polyethylene, and low density polyethylene.

15. The composition according to claim 14, further containing (F) at least one of a zinc oxide, and a benzimidazole compound.

16. The composition according to claim 9, further containing (F) at least one of a zinc oxide, and a benzimidazole compound.

17. The composition according to claim 8, wherein the functional group comprises a one or a plurality of functional groups selected from the group consisting of a carboxylic acid group, an acid anhydride group, an amino group, and an epoxy group.

18. The composition according to claim 17, wherein the polyolefin comprises a one or a plurality of polyethylene selected from the group consisting of ultralow density polyethylene, linear low density polyethylene, and low density polyethylene.

19. The composition according to claim 18, further containing (F) at least one of a zinc oxide, and a benzimidazole compound.

20. The composition according to claim 17, further containing (F) at least one of a zinc oxide, and a benzimidazole compound.

21. The composition according to claim 8, wherein the polyolefin comprises a one or a plurality of polyethylene selected from the group consisting of ultralow density polyethylene, linear low density polyethylene, and low density polyethylene.

22. The composition according to claim 21, further containing (F) at least one of a zinc oxide, and a benzimidazole compound.

23. The composition according to claim 8, further containing (F) at least one of a zinc oxide, and a benzimidazole compound.

24. An insulated wire including a wire coating material that contains the composition for the wire coating material according to claim 8, the composition being silane-crosslinked.

25. A wiring harness including the insulated wire according to claim 24
